(19) United States
(12) Patent Application Publication
(10) Pub. No.: US 2005/0276564 A1
(43) Pub. Date: Dec. 15, 2005

(54) Optical waveguide, light source, and optical amplifier

(76) Inventors: Motoki Kakui, Yokohama-shi (JP); Shinji Ishikawa, Yokohama-shi (JP); Tetsuya Haruna, Yokohama-shi (JP); Takahiro Murata, Onojo-shi (JP)

Correspondence Address: MCDERMOTT WILL & EMERY LLP, 600 13TH STREET, N.W., WASHINGTON, DC, 20005-3096, US

(21) Appl. No.: 11/118,754

(22) Filed: May 2, 2005

(30) Foreign Application Priority Data
May 6, 2004 (JP) P2004-137733

(51) Int. Cl. G02B 6/00

(52) U.S. Cl. 385/141

(57) ABSTRACT

The present invention relates to an optical waveguide and the like having a structure for generating a wide band of ASE. The optical waveguide comprises a material mainly comprised of glass or glass ceramics, and is at least partly doped with a rare earth element. In a spectrum of ASE generated in the optical waveguide when supplied with pumping light having a single wavelength in particular, a 15-dB band or 10-dB band includes a range from 1.45 μm to 1.65 μm or a range from 1.5 μm to 1.7 μm. Alternatively, a 3-dB band includes S, C, and L bands.

### BACKGROUND OF THE INVENTION

1. Field of the Invention

The present invention relates to an optical waveguide having a region doped with a rare earth element, a light source including the optical waveguide, and an optical amplifier including the light source.

2. Related Background Art

When an optical waveguide comprised of a material at least partly containing a rare earth element is supplied with pumping light capable of pumping the rare-earth element, the rare earth element within the optical waveguide attains an exited state. The rare earth element releases spontaneous emission when returning to its ground state from the excited state. Amplifying the spontaneous emission makes it possible to generate ASE (Amplified Spontaneous Emission) and amplify signal light using the phenomenon of induced emission. Therefore, employing such an optical waveguide can realize light sources and optical amplifiers.

For example, the light source disclosed in Japanese Patent Application Laid-Open No. 2002-329907 (Document 1) comprises an optical fiber comprised of silica glass at least partly containing Er element. According to Document 1, one example has an Er element concentration of 1200 ppm, an optical fiber length of 15 m, a pumping light wavelength of 1.48 μm, and a pumping light power of 130 mW. Here, the flatness of ASE spectrum (difference between the peak output intensity and minimum output intensity) in the wavelength region from 1.53 μm to 1.60 μm is 15 dB.

Meanwhile, a light source comprising an optical waveguide comprised of a material containing a rare earth element is usable for various purposes, and is employed, for example, when measuring insertion losses of passive optical components such as optical fibers. For such measurement, deviations in level among wavelengths of the ASE emission outputted from the light source are not a big problem, whereas it will be sufficient if output light can be obtained even when the output intensity of a certain wavelength is weak. Therefore, as described in the above-mentioned Document 1, a wavelength region having such an output intensity that the difference from a peak output intensity in an output light spectrum is 15 dB or less can be referred to as an output band of the light source without any problem.

### SUMMARY OF THE INVENTION

The inventors studied the conventional optical waveguide having a region doped with a rare earth element and, as a result, have found the following problems.

Namely, the output band of the light source described in the above-mentioned Patent Document 1 is not always sufficiently broad, whereby a light source which can output light whose peak output intensity and minimum output intensity yield a small difference therebetween over a wider wavelength region is desired. For example, the output band of the light source described in the above-mentioned Document 1 is insufficient for measuring the transmission loss of optical fibers employed in optical communications, for the purpose of so-called LIDAR (Light Detector and Ranging) or the like for measuring obstacles and the like in the air, for measuring the gain spectrum of optical amplifiers, and so forth.

It is desirable for, an optical communication system or the like amplifying signal light to be able to amplify a wide band of multiplexed signal light (signal light including a plurality of channels having wavelengths different from each other) by using a smaller number of optical amplifiers, whereby a wider gain band is demanded for the optical amplifier.

For overcoming the problems mentioned above, it is an object of the present invention to provide an optical waveguide comprising a structure for making it possible to generate ASE over a wider wavelength region, a light source including the optical waveguide, and an optical amplifier including the light source and having a wider gain band.

The optical waveguide according to the present invention is a rare-earth-element-doped optical waveguide comprised of a material at least partly containing a rare earth element. In particular, the optical waveguide is characterized in that, in a spectrum of ASE generated in the optical waveguide when pumping light having a single wavelength with a predetermined power is supplied thereto, a wavelength region (hereinafter referred to as 15-dB band) generating ASE with an intensity yielding a difference of 15 dB or less from a peak intensity in the spectrum includes a wavelength range from 1.45 μm to 1.65 μm. The 15-dB band may include a wavelength range from 1.5 μm to 1.7 μm. In the spectrum of ASE light, a wavelength region (hereinafter referred to as 10-dB band) generating ASE with an intensity yielding a difference of 10 dB or less from a peak intensity of ASE in the spectrum includes a wavelength range from 1.45 μm to 1.65 μm. The 10-dB band may include a wavelength range from 1.5 μm to 1.7 μm.

Since the 15-dB band or 10-dB band is a wide band, the optical waveguide according to the present invention is employable for various purposes, e.g., for measuring the transmission loss of optical fibers which are transmitting media for optical communications, and for the purpose of so-called LIDAR or the like for measuring obstacles and the like in the air. When measuring the transmission loss of an optical fiber which is a transmitting medium for optical communications, the optical waveguide whose 15-dB band or 10-dB band includes a wavelength range from 1.45 μm to 1.65 μm is employable, since the low transmission wavelength region of silica glass which is a material of the optical fiber ranges from 1.45 μm to 1.65 μm. The optical waveguide whose 15-dB band or 10-dB band includes a wavelength range from 1.5 μm to 1.7 μm is also employable for the purpose of so-called LIDAR or the like which measures obstacles and the like in the air, since the low transmission wavelength region of air ranges from 1.5 μm to 1.7 μm.

Preferably, in the optical waveguide according to the present invention comprising a material at least partly containing a rare earth element, a wavelength region corresponding to a full width at half maximum of the spectrum of ASE generated when pumping light having a single wavelength is supplied includes S band (1460 nm to 1530 nm), C band (1530 nm to 1565 nm), and L band (1565 nm to 1625 nm).

In the spectrum of ASE generated when pumping light having a single wavelength is supplied, a wavelength region (hereinafter referred to as 3-dB band) generating ASE with an intensity yielding a difference of 3 dB or less from the peak intensity of the ASE includes S, C, and L bands as such, whereby measurement of gain characteristics of various optical amplifiers employed in optical communications can effectively be prevented from being affected by spectral hole burning. Examples of optical amplifiers employed in optical communications include not only C-band EDFA (Erbium-Doped Fiber Amplifier) and L-band EDFA, but also TDFA (Thulium-Doped Fiber Amplifier) having a gain within a wavelength region from 1.46 μm to 1.48 μm and GS-TDFA (Gain-Shifted TDFA) having a gain within a wavelength region from 1.48 μm to 1.51 μm.

Preferably, in the optical waveguide according to the present invention comprising a material at least partly containing a rare earth element, the spectrum of ASE generated when pumping light having a single wavelength is supplied has a full width at half maximum of 20 THz or greater in terms of frequency.

In this case, the optical waveguide is favorably usable as a light source for optical coherence tomography (OCT). In particular, respective light components in S, C, and L bands are advantageous over the conventional wavelength region from 0.8 μm to 1.3 μm from the viewpoint of transmittance through living organisms. While the spatial resolution of OCT is usually desired to be 10 to 15 μm or less, the spatial resolution in the depth direction is given by the coherence length Lc of the light source. The coherence length Lc is obtained by the expression of Lc=c/Δv, where Δv is the full width at half maximum of the light source spectrum in terms of optical frequency. Here, c is the velocity of light in vacuum. Namely, for realizing a spatial resolution of 15 μm or less, it will be preferred if the full width at half maximum of the spectrum of light is at least 20 THz in terms of frequency. In sample E3 in FIG. 7, for example, the full width at half maximum is 1460 nm to 1650 nm, whereby Δv is 23.65 THz, so that Lc is narrowed to 12.7 μm.

Preferably, the optical waveguide according to the present invention has a polarization dependent transmittance (gain or loss) of less than 1 dB with respect to light transmitted therethrough from one end to the other end. It will be preferred if the outputted ASE has a degree of polarization of 1 dB or less. In these cases, the polarization dependent transmittance becomes smaller than that of semiconductor optical amplifiers.

Preferably, in the optical waveguide according to the present invention, the rare earth element used for doping comprises Er element and Tm element. In this case, the phenomenon of energy transfer between these atoms allows the ASE spectrum to attain a wider band. Yb element may further be contained as the rare earth element. This promotes the energy transfer phenomenon. Preferably, the molar concentration of Er element is set lower than that of Tm element. In this case, the level deviation in the ASE spectrum is lowered. Specifically, it will be preferred if the ratio of the molar concentration of Er element to the molar concentration of Tm element is 1:6 to 1:3. This lowers the level deviation in the ASE spectrum over a wide wavelength region.

Preferably, in the optical waveguide according to the present invention, the material at least partly containing the rare earth element is a material mainly comprised of glass or glass ceramics having a phonon energy of 900 cm⁻¹ or less, more preferably 600 cm⁻¹ or less. This makes it easier for the rare earth element to emit light, which can contribute to attaining a wider band.

The light source according to the present invention comprises an optical waveguide (an optical waveguide according to the present invention, hereinafter referred to as first optical waveguide) having the structure mentioned above, and a first pumping light supply system. Namely, the optical waveguide employed in the light source comprises a material at least partly containing a rare earth element as mentioned above. The first pumping light supply system supplies pumping light to the first optical waveguide. When the first pumping light supply system supplies the pumping light to the optical waveguide in this light source, ASE occurs in the first optical waveguide. Since the first optical waveguide employed in this light source is a rare-earth-element-doped optical waveguide comprised of a material at least partly containing a rare earth element as mentioned above, light outputted from the light source has a wide wavelength region.

The light source according to the present invention may further comprise an optical waveguide in addition to the first optical waveguide. In this case, the light source comprises the first optical waveguide, the first pumping light supply system, an additional optical waveguide, a second pumping light supply system, and an optical multiplexer. The additional optical waveguide is a transition-metal-element-doped optical waveguide (hereinafter referred to as second optical waveguide) comprised of a material at least partly containing a transition metal element. The second pumping light supply system supplies pumping light to the second optical waveguide. The optical multiplexer combines the ASE generated in the first optical waveguide with ASE generated in the second optical waveguide. When the second pumping light supply system supplies the pumping light to the second optical waveguide in such a configuration, the second optical waveguide generates ASE. The ASE generated in the first optical waveguide and the ASE generated in the second optical waveguide are combined together by the optical multiplexer, and thus combined light is outputted from the light source. The light outputted from the light source has a wider band including both the wavelength regions of the ASE generated in the first optical waveguide and the ASE generated in the second optical waveguide.

Preferably, in the light source according to the present invention, the pumping light supplied from the first pumping light supply system to the first optical waveguide has a wavelength in a 1.4-μm band. This yields a smaller output level deviation and a wider output band as compared with the case where the pumping wavelength is in a 0.98-μm band. This also reduces the danger of heat damages in the case where the host material is glass having a low phonon energy.

The optical amplifier according to the present invention comprises an input end, an output end, a first optical waveguide (an optical waveguide according to the present invention) having the structure mentioned above, and a first pumping light supply system. The first optical waveguide is a rare-earth-element-doped optical waveguide comprised of a material at least partly containing a rare earth element, and amplifies at least a part of a plurality of signal channels included in signal light taken therein by way of the input end. The first optical waveguide is disposed between the input end and the output end. The first pumping light supply system supplies pumping light to the first optical waveguide. Since the first optical waveguide employed in this optical waveguide is a rare-earth-element-doped optical waveguide comprised of a material at least partly containing a rare earth element as mentioned above, the optical waveguide has a wide gain band.

The optical amplifier according to the present invention may further comprise a second optical waveguide containing a dopant different from that of the first optical waveguide, a second pumping light supply system, an optical demultiplexer, and an optical multiplexer in addition to the configuration mentioned above. The second optical waveguide is a transition-metal-element-doped optical waveguide comprised of a material at least partly containing a transition metal element, and amplifies at least a part of a plurality of signal channels included in signal light taken therein by way of the input end. The second optical waveguide is disposed between the input end and output end together with the first optical waveguide. The second pumping light supply system supplies pumping light to the second optical waveguide. The optical demultiplexer demultiplexes a plurality of signal channels included in the signal light taken therein by way of the input end, guides a part of the demultiplexed plurality of signal channels to the first optical waveguide, and guides the rest of the plurality of signal channels to the second optical waveguide. The optical multiplexer combines the signal channels amplified by the first optical waveguide with the signal channels amplified by the second optical waveguide. In such a configuration, the second pumping light supply system supplies pumping light to the second optical waveguide. A plurality of signal channels included in the signal light inputted by way of the input end are divided into two groups by the optical demultiplexer, one group is guided to the first optical waveguide, and the other group is guided to the second optical waveguide. The signal channels guided to the first optical waveguide are amplified therein. The signal channels guided to the second optical waveguide are amplified therein. The signal channels amplified by the first optical waveguide and the signal channels amplified by the second optical waveguide are combined by the optical multiplexer, and thus combined light is outputted by way of the output end. The gain band of the optical waveguide becomes a wider band including both of the respective gain bands of the first and second optical waveguides.

Preferably, in the optical amplifier according to the present invention, the pumping light supplied from the first pumping light supply system to the first optical waveguide has a wavelength in a 1.4-μm band. This yields a smaller gain level deviation and a wider gain band as compared with the case where the pumping wavelength is in a 0.98-μm band. This also reduces the danger of heat damages in the case where the host material in the first and second optical waveguides employed in the optical amplifier is glass having a low phonon energy.

Embodiments according to the present invention will become more fully be understood from the detailed description given hereinbelow and the accompanying drawings. These embodiments are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the present invention, are given by illustration only, since various modifications and improvements within the spirit and scope of the invention will become apparent to those skilled in the art from this detailed description.

### BRIEF DESCRIPTION OF THE DRAWINGS

FIG. 1 is a perspective view showing the configuration of an optical fiber as an embodiment of the optical waveguide according to the present invention;

FIGS. 2A and 2B show ASE output spectra of an optical fiber comprising silica glass containing Er element and Tm element as rare earth elements in its core region when changing the composition ratio between Er and Tm elements;

FIG. 3 is a table listing respective compositions of optical fiber samples A to D prepared as examples of the optical waveguide;

FIG. 4 shows respective fluorescence spectra of the optical fiber samples A to D;

FIG. 5 is a table listing 15-dB bands and 10-dB bands concerning respective fluorescence spectra of optical fiber samples A to D;

FIG. 6 is a table listing respective compositions of optical fiber samples E1 to E6 prepared as examples of the optical waveguide;

FIG. 7 shows respective fluorescence spectra of optical fiber samples E1 to E6;

FIG. 8 shows ASE output spectra of an optical fiber comprising silica glass containing Er element and Tm element as rare earth elements in its core region when changing the pumping light wavelength;

FIG. 9 is a table listing 3-dB bands and 10-dB bands upon pumping with 0.98-μm and 1.4-μm bands;

FIG. 10 is a table listing respective compositions of optical fiber samples B2, C2 prepared as examples of the optical waveguide;

FIG. 11 shows respective fluorescence spectra of optical fiber samples B, B2;

FIG. 12 shows respective fluorescence spectra of optical fiber samples C, C2; and

FIG. 13 is a view showing the configuration of an embodiment of the optical amplifier according to the present invention (including an embodiment of the light source according to the present invention).

### DETAILED DESCRIPTION OF THE PREFERRED EMBODIMENTS

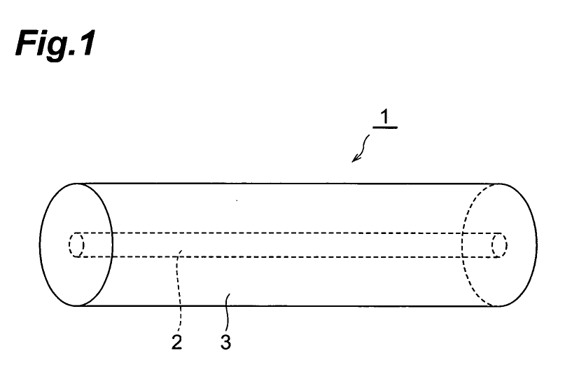

In the following, embodiments of the optical waveguide, light source, and optical amplifier according to the present invention will be explained in detail with reference to FIGS. 1, 2A, 2B, and 3 to 13. In the explanation of the drawings, constituents identical to each other will be referred to with numerals identical to each other without repeating their overlapping descriptions.

FIG. 1 is a perspective view showing the configuration of an optical fiber as an embodiment of the optical waveguide according to the present invention. The optical fiber 1 shown in FIG. 1, which is an optical waveguide constituted by a material mainly comprised of glass or glass ceramics, comprises a core region 2 having a high refractive index and a cladding region 3 with a low refractive index surrounding the outer periphery of the core region 2. The optical fiber 1 is a rare-earth-element-doped optical waveguide (first optical waveguide) containing a rare earth element (e.g., Er element, Tm element, Yb element, etc.) at least in the core region 2. The optical fiber 1 has a cutoff wavelength of about 0.9 μm and a mode field diameter of about 6.0 μm at a wavelength of 1.55 μm.

When the optical fiber 1 is supplied with pumping light having a wavelength capable of pumping the rare earth element contained therein, the rare earth element attains an excited state. When the rare earth element returns to its ground state from the excited state, spontaneous emission is released therefrom. Amplifying the spontaneous emission makes it possible to generate ASE or amplify signal light using the phenomenon of induced emission. Therefore, employing such an optical waveguide 1 can realize light sources and optical amplifiers.

The optical fiber 1 is characterized in that the 15-dB wavelength region or 10-dB wavelength region in an ASE spectrum occurring when supplied with pumping light having a single wavelength includes a wavelength range from 1.45 μm to 1.65 μm or from 1.5 μm to 1.7 μm. Alternatively, the optical fiber 1 is characterized in that the 3-dB band includes S, C, and L bands.

Preferably, the optical fiber 1 has a polarization dependent transmittance (gain or loss) of less than 1 dB with respect to light transmitted therethrough from one end to the other end. It will be preferred if the outputted ASE has a degree of polarization of 1 dB or less. In these cases, the polarization dependent transmittance becomes smaller than that of semiconductor optical amplifiers.

Preferably, the optical fiber 1 contains Er element and Tm element as rare earth elements. In this case, the phenomenon of energy transfer between these atoms allows the ASE spectrum to attain a wider band. Yb element may further be contained as a rare earth element. This promotes the energy transfer phenomenon. Preferably, the molar concentration of Er element is set lower than that of Tm element. In this case, the level deviation in the ASE spectrum is lowered. Specifically, it will be preferred if the ratio of the molar concentration of Er element to the molar concentration of Tm element is 1:6 to 1:3. In this case, the fluorescence due to Er element and the fluorescence due to Tm element become substantially equal to each other, thereby lowering the level deviation in the ASE spectrum over a wide wavelength region.

Preferably, the optical fiber 1 comprises a material mainly comprised of glass or glass ceramics having a phonon energy of 900 cm⁻¹ or less, more preferably 600 cm⁻¹ or less. This makes it easier for the rare earth element to emit light, which can contribute to attaining a wider band.

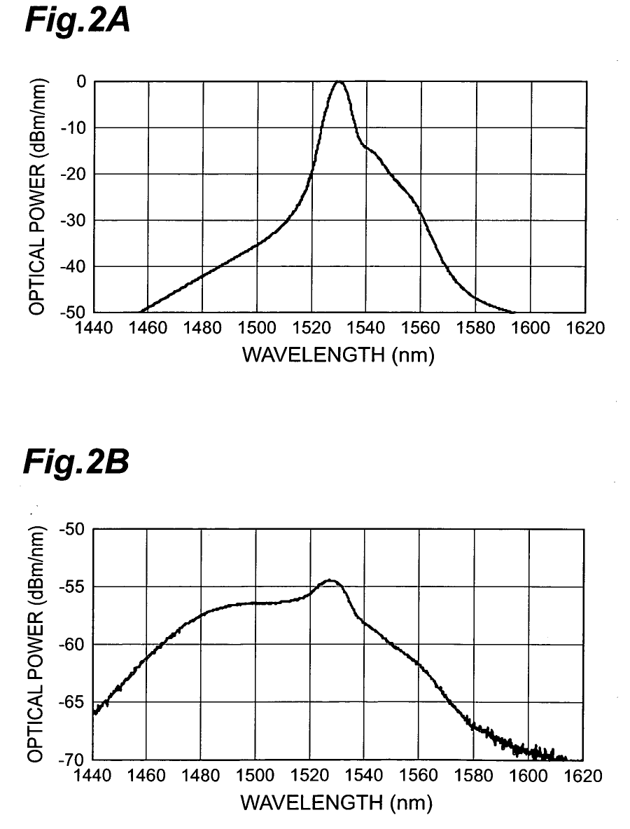

FIGS. 2A and 2B show ASE output spectra of an optical fiber comprising silica glass containing Er element and Tm element as rare earth elements in its core region. Namely, FIG. 2A shows an ASE output spectrum of an optical fiber whose core region is doped with 500 wt.ppm of Er element and 500 wt.ppm of Tm element, whereas FIG. 2B shows an ASE output spectrum of an optical fiber whose core region is doped with 25 wt.ppm of Er element and 500 wt.ppm of Tm element. In the measurement of the respective spectra of FIGS. 2A and 2B, each of the optical fibers prepared has a length of 30 mm, the pumping light is supplied forwardly, the pumping wavelength is in the 0.98-μm band, and the pumping light power is 100 mW. In the measurement of the spectra shown in FIGS. 2A and 2B, the wavelength resolution is 1 nm.

When the Er element and Tm element are the same in terms of weight concentration, the 15-dB band ranges from 1523 nm to 1540 nm with a width of only 17 nm as shown in FIG. 2A. This is because of the fact that the phonon energy of silica glass acting as a host material is so high that the fluorescence of Tm element is hard to achieve in such silica glass. When the weight concentration of Er element is 1/20 that of Tm element, on the other hand, the 15-dB band ranges from 1440 nm to 1590 nm with a greater width as shown in FIG. 2B. As can be seen from this fact, it will be preferred if the concentration of Er element is set lower than that of Tm element in order to attain a wider spectrum band.

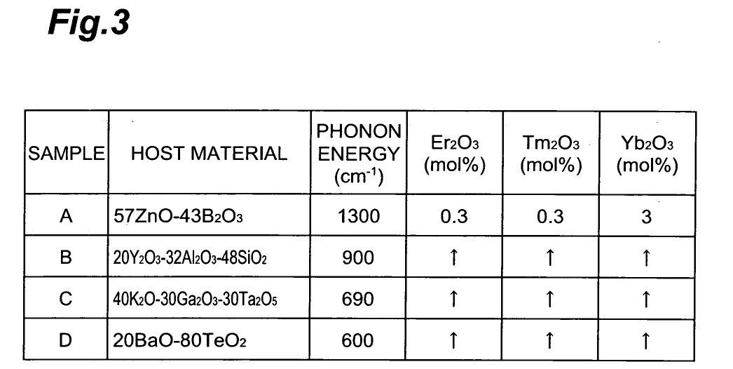

Even when the Er element and Tm element are on a par with each other in terms of weight concentration, however, fluorescence can be obtained in a wide wavelength region if the phonon energy of the host material is small as shown in FIGS. 3 to 5.

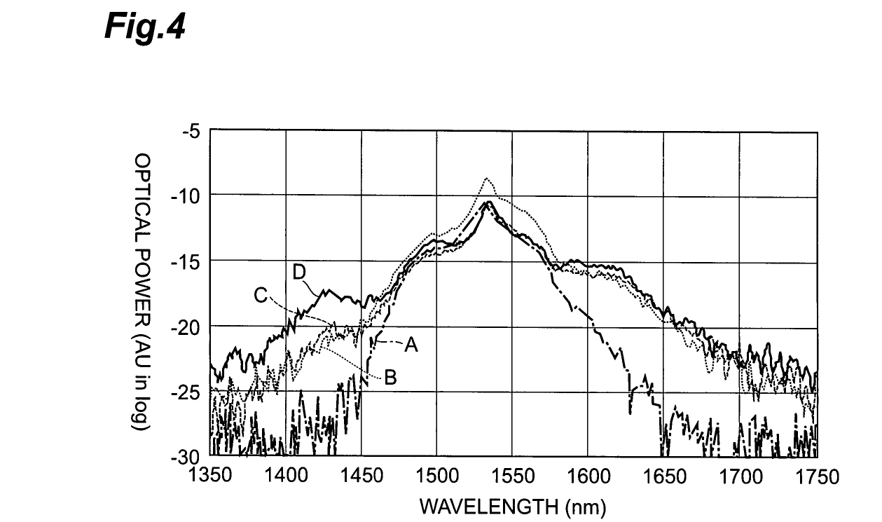

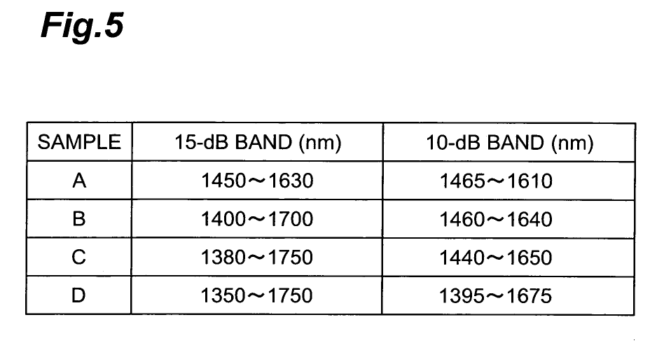

FIG. 3 is a table listing respective compositions of optical fiber samples A to D prepared as examples of the optical waveguide. FIG. 4 shows respective fluorescence spectra of optical fiber samples A to D. FIG. 5 is a table listing 15-dB and 10-dB bands concerning the fluorescence spectra of optical fiber samples A to D.

As shown in FIG. 3, the host material of sample A contains 57 mol % of ZnO and 43 mol % of B₂O₃, while having a phonon energy of 130 cm⁻¹. The host material of sample B contains 20 mol % of Y₂O₃, 32 mol % of Al₂O₃, and 48 mol % of Si₂O₃, while having a phonon energy of 900 cm⁻¹. The host material of sample C contains 40 mol % of K₂O, 30 mol % of Ga₂O₃, and 30 mol % of Ta₂O₅, while having a phonon energy of 690 cm⁻¹. The host material of sample D contains 20 mol % of BaO and 80 mol % of TeO₂, while having a phonon energy of 600 cm⁻¹. The compositions of host materials refer to those before containing the rare earth elements. Each of samples A to D contains 0.3 mol % of Er₂O₃, 0.3 mol % of Tm₂O₃, and 3 mol % of Yb₂O₃, whereby the molar concentration of Er element and the molar concentration of Tm element are equal to each other.

FIG. 4 shows spectra of fluorescence occurring in the respective host materials of the samples when irradiated with pumping light in the wavelength band of 0.98 μm. As shown in FIGS. 4 and 5, sample A has a 15-dB band ranging from 1450 nm to 1630 nm and a 10-dB band ranging from 1465 nm to 1610 nm. Sample B has a 15-dB band ranging from 1400 nm to 1700 nm and a 10-dB band ranging from 1460 nm to 1640 nm. Sample C has a 15-dB band ranging from 1380 nm to 1750 nm and a 10-dB band ranging from 1440 nm to 1650 nm. Sample D has a 15-dB band ranging from 1350 nm to 1750 nm and a 10-dB band ranging from 1395 nm to 1675 nm.

As can be seen from FIG. 5, each of samples B, C, and D with a phonon energy of 900 cm⁻¹ or less has a 15-dB band including a range from 1.45 μm to 1.70 μm, and thus is suitable not only for measuring the transmission loss of an optical component such as optical fiber employed in a transmission medium for optical communications, but also for the purpose of so-called LIDAR or the like for measuring obstacles and the like in the air. Each of samples C and D has a 10-dB band including a range from 1.45 μm to 1.65 μm. Thus, even when doped with the same molar concentration of Er element and Tm element, a wide band of fluorescence can be obtained if the phonon energy of the host material is sufficiently small.

An energy transfer from Er element to Tm element in the host material causes Tm element to emit fluorescence. Namely, Er element acts as a sensitizer when Tm element is excited. Similarly, Yb element acts as a sensitizer when Er element is excited. Therefore, it will be preferred if the host material is doped with Yb element in addition to Er element and Tm element as in the above-mentioned samples A to D. Doping with Yb element promotes the fluorescence of each of Er element and Tm element.

In the case of a host material having a relatively high phonon energy, it will be preferred if the molar concentration of Er element is set lower than the molar concentration of Tm element, the molar concentration of Er element is set lower than the molar concentration of Yb element by about one digit, and the molar concentration of Tm element is set lower than the molar concentration of Yb element.

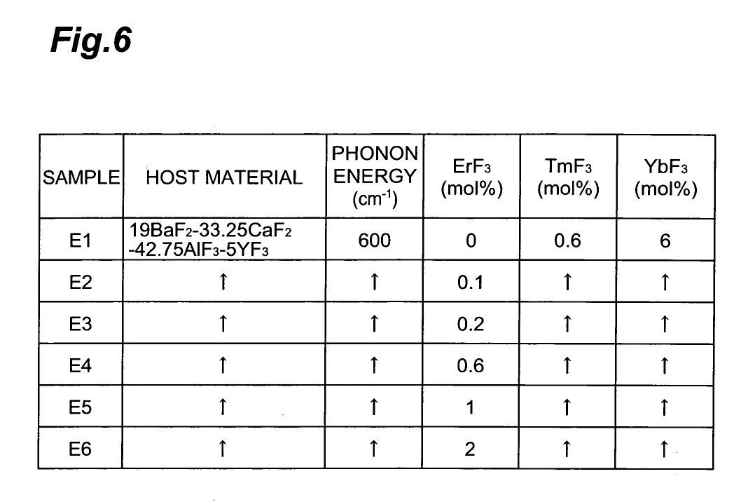

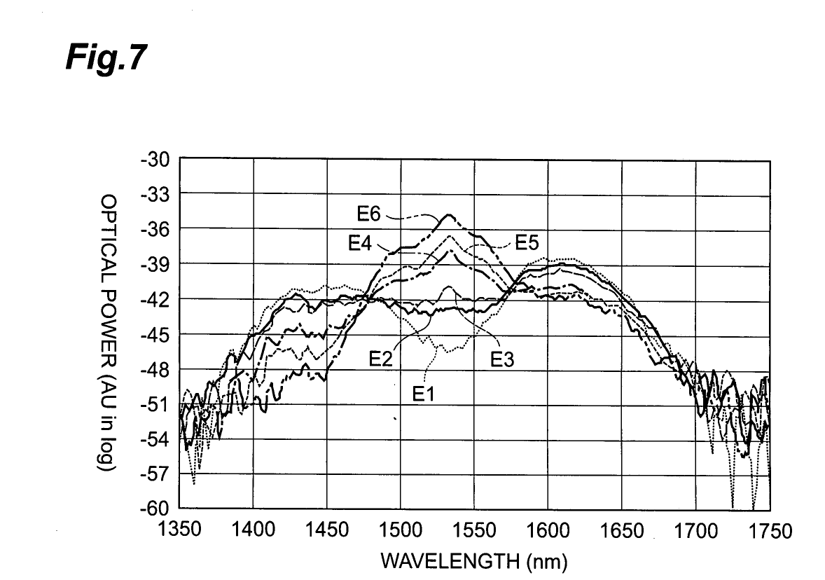

FIG. 6 is a table listing respective compositions of optical fiber samples E1 to E6 prepared as examples of the optical waveguide. FIG. 7 shows respective fluorescence spectra of optical fiber samples E1 to E6.

As shown in FIG. 6, each of the respective host materials of samples E1 to E6 contains 19 mol % of BaF₂, 33.25 mol % of CaF₂, 42.75 mol % of AlF₃, and 5 mol % of YF₃, while having a phonon energy of 600 cm⁻¹. The compositions of host materials refer to those before containing rare earth elements. Each of samples E1 to E6 contains 0.6 mol % of TmF₃ and 6 mol % of YbF₃. The ErF₃ content differs among samples E1 to E6. The ErF₃ content is 0 in sample E1, 0.1 mol % in sample E2, 0.2 mol % in sample E3, 0.6 mol % in sample E4, 1 mol % in sample E5, and 2 mol % in sample E6.

In the case of samples E5 and E6 in which the molar concentration of Er element is higher than the molar concentration of Tm element, Tm element is presumed to act as an absorber with respect to fluorescence generated by Er element, whereby a fluorescence spectrum having a peak in the wavelength band of 1.53 μm is obtained as shown in FIG. 7. In the case of samples E1 to E3 in which the molar concentration of Er element is lower than the molar concentration of Tm element, by contrast, the fluorescence bulges in wavelength regions other than C band.

In the case of samples E3 and E4 in which the ratio of the molar concentration of Er element to the molar concentration of Tm element is 1:6 to 1:3 in particular, the 3-dB band includes a range from 1460 nm to 1625 nm (i.e., S, C, and L bands according to ITU standards). Therefore, light sources employing sample E3 or E4 are suitable for measuring the gain characteristic measurement of each of TDFA, GS-TDFA, C-band EDFA, and L-band EDFA used for optical communications.

Since rare-earth-element-doped optical fiber amplifiers such as TDFA, GS-TDFA, C-band EDFA, and L-band EDFA are assumed to approximate a homogeneous-broadening model, precision measurement of a gain spectrum utilizing a broadband white light source can be considered. For this purpose, it is required that the influence of spectral hole burning be minimized. Therefore, the output power spectrum of the white light source is preferably as flat as possible, whereas the deviation in the gain band of the rare-earth-element-doped optical fiber amplifier is preferably 3 dBₚ₋ₚ or less. The ASE spectra of samples E3 and E4 satisfy such a condition. Though not containing Er element, sample E1 attains a 10-dB band ranging from 1380 nM to 1700 nm by Tm element alone.

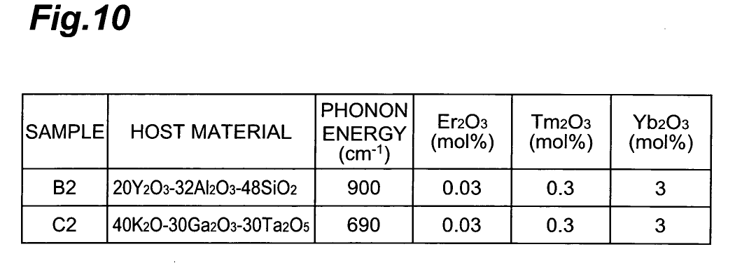

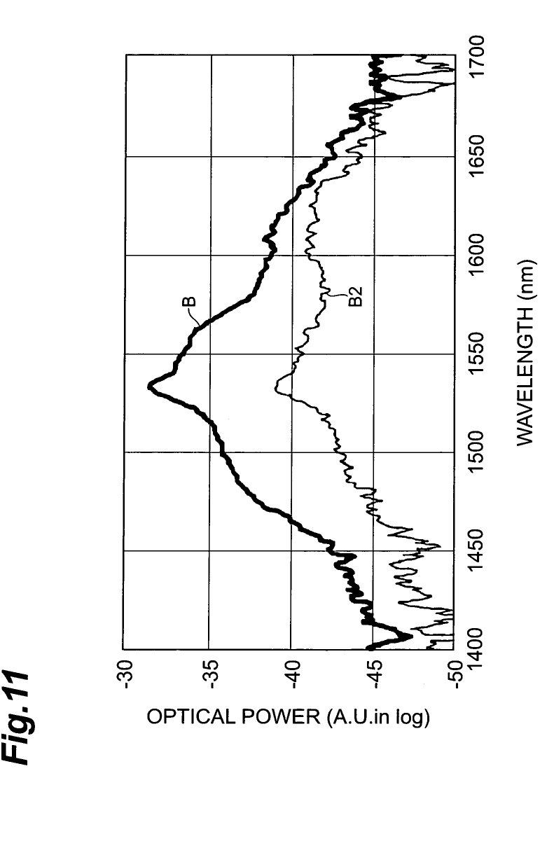

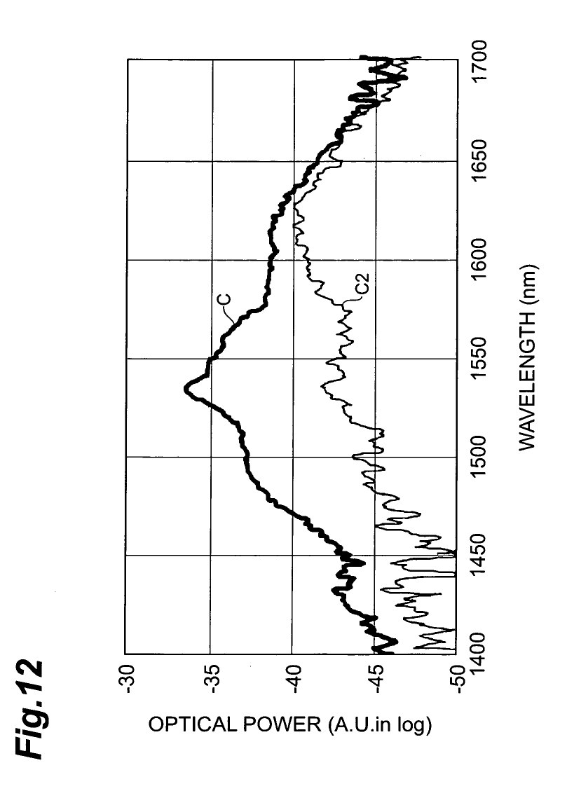

FIGS. 11 and 12 show fluorescence spectra obtained when changing the molar concentration ratio between Er and Tm in host glass materials other than sample E. Here, the host glass matrix of sample B2 shown in FIG. 11 is the same as sample B, whereas the host glass matrix of sample C2 shown in FIG. 12 is the same as sample C. FIG. 10 is a table listing respective compositions of optical fiber samples B2, C2. FIG. 11 shows respective fluorescence spectra of optical fiber samples B, B2. FIG. 12 shows respective fluorescence spectra of optical fiber samples C, C2. Each of the host materials of samples B2 and C2 contains 0.03 mol % of Er₂O₃, and 3 mol % of Yb₂O₃.

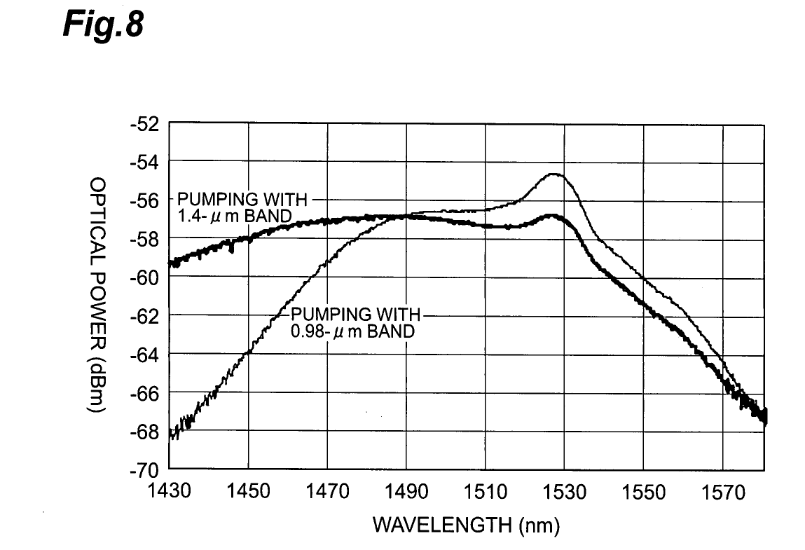

The fluorescence spectra shown in FIG. 7 realize flat ASE over S, C, and L bands, whereas the fluorescence spectra shown in FIG. 8 realize flat ASE in S band. By contrast, the fluorescence spectra shown in FIGS. 11 and 12 realize flat ASE over C and L bands. In spite of the fact that the phonon energy of sample B2 is close to the phonon energy of silica-based glass, such a difference from FIG. 8 occurs mainly because of the molar concentration of Yb element added.

Namely, the molar concentration of Yb element in sample B2 is about 10 times higher than the molar concentration of Tm element, so that the transition between ²F_{5/2} and ²F_{7/2} of Yb ions (i.e., fluorescence in the wavelength band of 1.06 μm) becomes dominant rather than the transition between ³H₄ and ³F₄ of Tm ions, thereby suppressing the fluorescence in S band.

Here, the existence of Yb ions does not affect the energy transfer from the ⁴I_{13/2} level of Er ions to the ³H₄ level or ³F₄ level of Tm ions, whereby the fluorescence of Tm ions over L to U bands can be obtained without any problem.

When the molar concentration of Yb ions is optimized, host glass samples B2, C2 can also yield a 3-dB band covering S to L bands as shown in FIG. 7. Here, the optimal molar concentration ratio of Er, Tm, and Yb depends on the phonon energy of host glass, and may differ from the examples shown in FIG. 7.

For example, the fluorescence in S band due to Tm in sample C2 is at a value lower than the fluorescence in L to U bands. This seems to be because of the fact that the energy difference between ³H₄ and ³H₅ in Tm ions is so small that the transition between these levels becomes stronger, thereby weakening the transition between ³H₄ and ³F₄. Though samples E1 to E6 shown in FIG. 7 do not greatly differ from samples C, C2 in terms of phonon energy, a slight difference in phonon energy seems to be greatly influential, since the multiphonon relaxation rate changes exponentially with respect to the phonon energy.

In general, the adjustment in molar concentration ratio of Er, Tm, and Yb is expected to have the following effects. Namely, the adjustment in molar concentration between Er and Tm can contribute to optimizing the power ratio between the fluorescence in C band and the fluorescence in S, L, and U bands. On the other hand, the adjustment in molar concentration between Yb and Tm can contribute to optimizing the power ratio between the fluorescence in S band and the fluorescence in L and U bands.

When the ASE power is weak, the ASE emitted by an optical amplifier to be measured may become dominant at the time of measuring respective gain spectra of TDFA, GS-TDFA, C-band EDFA, and L-band EDFA, thus failing to perform accurate measurement. In this case, however, it will be sufficient if a time-sharing process is utilized, in which ASE fed into the optical amplifier is turned on and off sufficiently faster than the excitation life of active ions involved in amplification in the optical amplifier to be measured, and the output spectrum without ASE input is subtracted from the output spectrum with ASE input, so as to yield an effective post-ASE-amplification output.

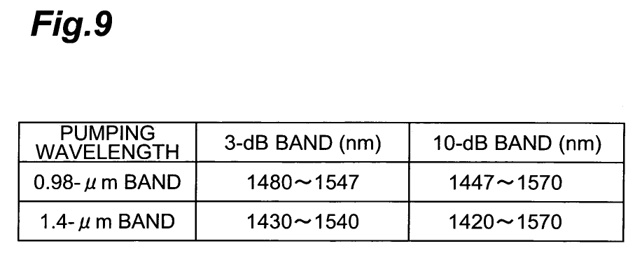

FIG. 8 shows ASE output spectra of an optical fiber comprised of silica glass containing Er element and Tm element as rare earth elements in its core region. FIG. 8 shows the ASE output spectrum obtained when pumping light in the wavelength band of 0.98 μm is supplied, and the ASE output spectrum obtained when pumping light in the wavelength band of 1.4 μm is supplied. FIG. 9 is a table listing 3-dB bands and 10-dB bands upon pumping with 0.98-μm and 1.4-μm bands. As can be seen from FIGS. 8 and 9, the pumping with the 0.98-μm band yields a 3-dB band ranging from 1480 nm to 1547 nm and a 10-dB band ranging from 1447 nm to 1570 nm. On the other hand, the pumping with the 1.4-μm band yields a 3-dB band ranging from 1430 nm to 1540 nm and a 10-dB band ranging from 1420 nm to 1570 nm. Thus, the pumping with the 1.4-μm band yields a wider band than does the pumping with the 0.98-μm band.

The pumping with the 1.4-μm band can efficiently excite Tm element from the ³F₄ level to the ³H₄ level, so as to enhance the population inversion between these levels, thereby expanding the fluorescence in S band to a shorter wavelength. In the pumping with the 1.4-μm band, on the other hand, the fluorescence peak due to Er element near the wavelength band of 1.53 μm is slackened, since the pumping light absorbing efficiency of Er element is low. As a consequence, the pumping with the 1.4-μm band yields a wider band. The pumping with the 1.4-μm band yields a wider band not only in the case where the host material is silica glass but also in the case of host materials having a low phonon energy shown in FIGS. 3 and 6.

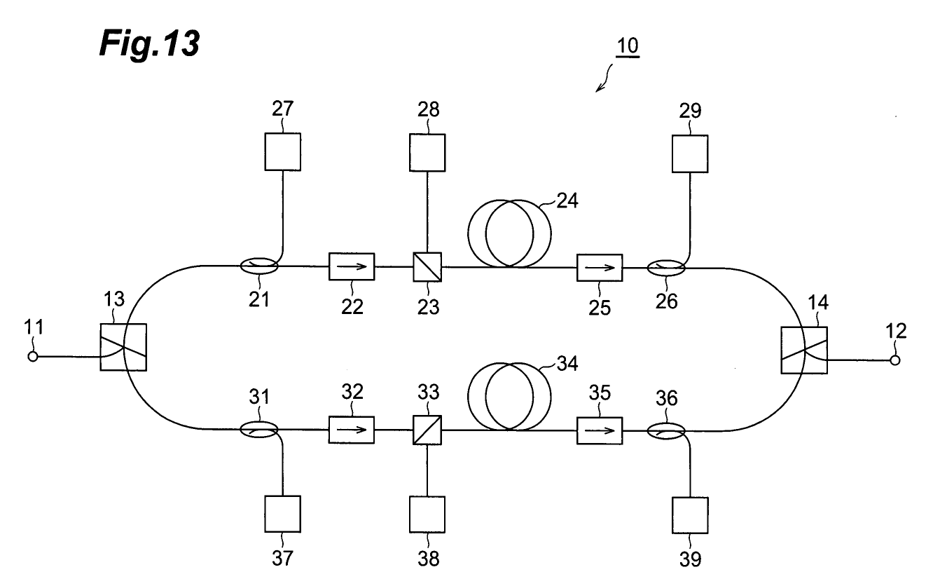

FIG. 13 is a view showing the configuration of an embodiment of the optical amplifier according to the present invention. The optical amplifier 10 shown in FIG. 13 is also usable as a light source (a light source according to the present invention). The optical amplifier 10 amplifies signal light fed therein by way of an input end, and outputs thus amplified signal light from an output end 12. For this purpose, the optical amplifier 10 comprises a WDM optical filter 13 disposed on the input end 11 side and a WDM optical filter 14 disposed on the output end 12 side, whereas two signal paths are provided between the WDM optical filters 13 and 14.

The optical amplifier 10 comprises an optical coupler 21, an optical isolator 22, an optical coupler 23, an optical fiber 24, an optical isolator 25, and an optical coupler 26 which are successively arranged along one signal path; and an optical coupler 31, an optical isolator 32, an optical coupler 33, an optical fiber 34, an optical isolator 35, and an optical coupler 36 which are successively arranged along the other signal path. The optical amplifier 10 further comprises an input monitor part 27 connected to the optical coupler 21, a pumping light source 28 connected to the optical coupler 23, an output monitor part 29 connected to the optical coupler 26, an input monitor part 37 connected to the optical coupler 31, a pumping light source 38 connected to the optical coupler 33, and an output monitor part 39 connected to the optical coupler 36.

The WDM optical filter 13 demultiplexes a plurality of signal channels included in the signal light fed therein by way of the input end 11, outputs one of the demultiplexed plurality of signal channels to the optical coupler 21, and outputs the rest of the plurality of signal channels to the optical coupler 31.

The optical coupler 21 branches out a part of the power of signal channels having arrived from the WDM optical filter 13, outputs the branched light to the input monitor part 27, and outputs the rest to the optical isolator 22. The optical isolator 22 transmits light therethrough in the forward direction from the optical coupler 21 to the optical coupler 23, but not in the opposite direction. The optical coupler 23 outputs to the optical fiber 24 not only the signal channels having arrived from the optical isolator 22 but also the pumping light having arrived from the pumping light source 28.

At least a part of the core of the optical fiber 24 is an optical fiber (an embodiment of the optical waveguide according to the present invention) comprised of a material at least partly containing a rare earth element and having the structure mentioned above. The optical fiber 24 is supplied with the pumping light outputted from the pumping light source 28, and collectively amplifies the signal channels outputted from the optical coupler 23. Thus amplified signal channels are outputted to the optical isolator 25. The optical isolator 25 transmits therethrough light in the forward direction from the optical fiber 24 to the optical coupler 26, but not in the opposite direction. The optical coupler 26 branches out a part of the power of signal channels having arrived from the optical isolator 25, outputs thus branched light to the output monitor part 29, and outputs the rest to the WDM optical filter 14.

The optical coupler 31 branches out a part of the power of signal channels having arrived from the WDM optical filter 13, outputs thus branched light to the input monitor part 37, and outputs the rest to the optical isolator 32. The optical isolator 32 transmits light therethrough in the forward direction from the optical coupler 31 to the optical coupler 33, but not in the opposite direction. The optical coupler 33 outputs to the optical fiber 34 not only the signal channels having arrived from the optical isolator 32 but also the pumping light having arrived from the pumping light source 38.

The optical fiber 34 is an optical fiber comprised of a material at least partly containing a transition metal element (e.g., Bi element). When supplied with the pumping light outputted from the pumping light source 38, the optical fiber 34 amplifies the signal channels outputted from the optical coupler 33. Thus amplified signal channels are outputted to the optical isolator 35. When the optical fiber 34 contains Bi element as a transition metal element, the 0.8-μm band is used as a pumping wavelength. The optical isolator 35 transmits light therethrough in the forward direction from the optical fiber 34 to the optical coupler 36, but not in the opposite direction. The optical coupler 36 branches out a part of the power of signal channels having arrived from the optical isolator 35, outputs thus branched light to the output monitor part 39, and outputs the rest to the WDM optical filter 14.

The WDM optical filter 14 combines the signal channels having arrived from the optical coupler 26 with the signal channels having arrived from the optical coupler 36, and outputs thus combined light from the output end 12 to the outside of the optical amplifier 10.

The optical amplifier 10 operates as follows. The pumping light outputted from the pumping light source 28 is supplied to the optical fiber 24 by way of the optical coupler 23. On the other hand, the pumping light outputted from the pumping light source 38 is supplied to the optical fiber 34 by way of the optical coupler 33. A plurality of signal channels of signal light inputted by way of the input end 11 are demultiplexed by the WDM optical filter 13, a branched part of the plurality of signal channels are outputted to the optical coupler 21, and the rest of the plurality of signal channels are outputted to the optical coupler 31.

The signal channels outputted from the WDM optical filter 13 to the optical coupler 21 successively travel the optical coupler 21, optical isolator 22, and optical coupler 23, thereby reaching the optical fiber 24, and are amplified while being guided through the optical fiber 24. The signal channels amplified by the optical fiber 24 successively travel the optical isolator 25 and optical coupler 26, thereby reaching the WDM optical filter 14.

On the other hand, the signal channels outputted from the WDM optical filter 13 to the optical coupler 31 successively travel the optical coupler 31, optical isolator 32, and optical coupler 33, thereby reaching the optical fiber 34, and are amplified while being guided through the optical fiber 34. The signal channels optically amplified by the optical fiber 34 successively travel the optical isolator 35 and optical coupler 26, thereby reaching the WDM optical filter 14.

The signal channels outputted from the optical coupler 26 and the signal channels outputted from the optical coupler 36 are combined together by the WDM optical filter 14, and thus combined light is outputted from the output end 12 to the outside of the optical amplifier 10.

The gain band of the optical amplifier 10 includes the gain band of the optical fiber 24 comprised of a material at least partly containing a rare earth element and the gain band of the optical fiber 34 comprised of a material at least partly containing a transition metal element (e.g., Bi element). On the other hand, the gain band of one optical fiber 24 includes a wavelength range from 1.45 μm to 1.65 μm or a wavelength range from 1.5 μm to 1.7 μm as a 10-dB band, or a wavelength range from 1460 nm to 1625 nm as a 3-dB band, and thus is a wide band by itself When the other optical fiber 32 contains Bi element as a transition metal element, the gain band of the optical fiber 32 includes 0 band (1260 nm to 1360 nm). Therefore, the optical amplifier 10 attains a gain over a wide band ranging from 0 band to L band.

The optical amplifier 10 is also usable as a light source (a light source according to the present invention) having a wide band of ASE output spectrum. The WDM optical filter 13, optical couplers 21, 31, optical isolators 22, 32, and input monitor parts 27, 37 are unnecessary in this case.

The O band is a wavelength band used in optical broadcasting systems such as CATV. Therefore, the optical amplifier 10 or light source can be employed when evaluating optical components used for both purposes of optical communications and optical broadcasting. The optical amplifier 10 or light source is also applicable to near infrared spectrophotometry and the like.

The optical amplifier 10 shown in FIG. 13 has a structure in which the optical fiber 24 containing a rare earth element and the optical fiber 34 containing a transition metal element are arranged in parallel. An optical fiber containing a transition metal element in addition to a rare earth element may be employed as well. This can also realize an optical amplifier or light source having a wide band. For example, when pumping light in the 0.8-μm band is supplied to the optical fiber containing Er element, Tm element, and Bi element, both of Bi element and Er element are excited, so that the fluorescence in the 1.26-μm band from Bi element excites Tm element from the ³H₆ level to the ³H₅ level, whereas the fluorescence in the 1.53-μm band from Er element excites Tm element from the ³H₆ level to the ³F₄ level, whereby three species of elements generate respective kinds of fluorescence. In order for Tm element to generate a population inversion, it is desirable that the Bi element concentration be higher than the Er element concentration.

The configuration additionally codoped with Yb is further useful for flattening the wide band of ASE optical output spectrum such as the one mentioned above if the respective molar concentrations of elements are optimized.

As in the foregoing, the present invention can generate a wide band of ASE, and allows the gain band to become wider.

It is clear from the foregoing description of the present invention that the invention can be modified in various ways. Such modifications are not considered to depart from the spirit and scope of the present invention, and improvements apparent to any of those skilled in the art are included in the following claims.

1. An optical waveguide comprised of a material at least partly containing a rare earth element;
wherein, in a spectrum of ASE generated in said optical waveguide when pumping light having a single wavelength is supplied thereto, a wavelength region generating ASE with an intensity yielding a difference of 15 dB or less from a peak intensity of the spectrum includes a wavelength range from 1.45 μm to 1.65 μm.

2. An optical waveguide according to claim 1, wherein, in the spectrum of ASE, a wavelength region generating ASE with an intensity yielding a difference of 10 dB or less from a peak intensity of the spectrum includes a wavelength range from 1.45 μm to 1.65 μm.

3. An optical waveguide according to claim 1, wherein said optical waveguide has a polarization dependent transmittance of less than 1 dB with respect to light transmitted therethrough from one end to the other end.

4. An optical waveguide according to claim 1, wherein the ASE outputted therefrom has a degree of polarization of 1 dB or less.

5. An optical waveguide according to claim 1, wherein the rare earth element includes Er element and Tm element.

6. An optical waveguide according to claim 5, wherein the rare earth element further includes Yb element.

7. An optical waveguide according to claim 5, wherein the Er element has a molar concentration set lower than that of the Tm element.

8. An optical waveguide according to claim 7, wherein the molar concentration of the Er element and the molar concentration of the Tm element have a ratio of 1:6 to 1:3 therebetween.

9. An optical waveguide according to claim 1, wherein said optical waveguide comprises a material mainly comprised of glass or glass ceramics having a phonon energy of 900 cm⁻¹ or less.

10. An optical waveguide according to claim 1, wherein said optical waveguide comprises a material mainly comprised of glass or glass ceramics having a phonon energy of 600 cm⁻¹ or less.

11. A light source comprising:
an optical waveguide according to claim 1; and
a first pumping light supply system for supplying said optical waveguide with pumping light.

12. A light source according to claim 11, further comprising:
an additional optical waveguide comprised of a material at least partly containing a transition metal element;
a second pumping light supply system for supplying said additional optical waveguide with pumping light; and
an optical multiplexer for combining the ASE generated in said optical waveguide with ASE generated in said additional optical waveguide.

13. A light source according to claim 11, wherein the pumping light supplied from said first pumping light supply system to said optical waveguide has a wavelength in a band of 1.4 μm.

14. An optical amplifier comprising:
an input end;
an output end;
an optical waveguide according to claim 1, disposed between said input end and said output end, for amplifying at least a part of a plurality of signal channels included in signal light taken therein by way of said input end; and
a first pumping light supply system for supplying said optical waveguide with pumping light.

15. An optical amplifier according to claim 14, further comprising:
an additional optical waveguide, disposed between said input end and output end and comprised of a material at least partly containing a transition metal element, for amplifying at least a part of a plurality of signal channels included in the signal light taken therein by way of said input end;
a second pumping light supply system for supplying said additional optical waveguide with pumping light;
an optical demultiplexer for demultiplexing the signal light taken therein by way of said input end, supplying a part of the demultiplexed plurality of signal channels to said optical waveguide, and supplying the rest of the plurality of signal channels to said additional optical waveguide; and
an optical multiplexer for combining the signal channels amplified by said optical waveguide with the signal channels amplified by said additional optical waveguide.

16. An optical amplifier according to claim 14, wherein the pumping light supplied from said first pumping light supply system to said optical waveguide has a wavelength in a 1.4-μm band.

17. An optical waveguide comprised of a material at least partly containing a rare earth element;
wherein, in a spectrum of ASE generated in said optical waveguide when pumping light having a single wavelength is supplied thereto, a wavelength region generating ASE with an intensity yielding a difference of 15 dB or less from a peak intensity of the spectrum includes a wavelength range from 1.5 μm to 1.7 μm.

18. An optical waveguide according to claim 17, wherein, in the spectrum of ASE, a wavelength region generating ASE with an intensity yielding a difference of 10 dB or less from a peak intensity of the spectrum includes a wavelength range from 1.5 μm to 1.7 μm.

19. An optical waveguide according to claim 17, wherein said optical waveguide has a polarization dependent transmittance of less than 1 dB with respect to light transmitted therethrough from one end to the other end.

20. An optical waveguide according to claim 17, wherein the ASE outputted therefrom has a degree of polarization of 1 dB or less.

21. An optical waveguide according to claim 17, wherein the rare earth element includes Er element and Tm element.

22. An optical waveguide according to claim 21, wherein the rare earth element further includes Yb element.

23. An optical waveguide according to claim 21, wherein the Er element has a molar concentration set lower than that of the Tm element.

24. An optical waveguide according to claim 23, wherein the molar concentration of the Er element and the molar concentration of the Tm element have a ratio of 1:6 to 1:3 therebetween.

25. An optical waveguide according to claim 17, wherein said optical waveguide comprises a material mainly comprised of glass or glass ceramics having a phonon energy of 900 cm⁻¹ or less.

26. An optical waveguide according to claim 17, wherein said optical waveguide comprises a material mainly comprised of glass or glass ceramics having a phonon energy of 600 cm⁻¹ or less.

27. A light source comprising:
an optical waveguide according to claim 17; and
a first pumping light supply system for supplying said optical waveguide with pumping light.

28. A light source according to claim 27, further comprising:
an additional optical waveguide comprised of a material at least partly containing a transition metal element;
a second pumping light supply system for supplying said additional optical waveguide with pumping light; and
an optical multiplexer for combining the ASE generated in said optical waveguide with ASE generated in said additional optical waveguide.

29. A light source according to claim 27, wherein the pumping light supplied from said first pumping light supply system to said optical waveguide has a wavelength in a band of 1.4 μm.

30. An optical amplifier comprising:
an input end;
an output end;
an optical waveguide according to claim 17, disposed between said input end and said output end, for amplifying at least a part of a plurality of signal channels included in signal light taken therein by way of said input end; and
a first pumping light supply system for supplying said optical waveguide with pumping light.

31. An optical amplifier according to claim 30, further comprising:
an additional optical waveguide, disposed between said input end and output end and comprised of a material at least partly containing a transition metal element, for amplifying at least a part of a plurality of signal channels included in the signal light taken therein by way of said input end;
a second pumping light supply system for supplying said additional optical waveguide with pumping light;
an optical demultiplexer for demultiplexing the signal light taken therein by way of said input end, supplying a part of the demultiplexed plurality of signal channels to said optical waveguide, and supplying the rest of the plurality of signal channels to said additional optical waveguide; and
an optical multiplexer for combining the signal channels amplified by said optical waveguide with the signal channels amplified by said additional optical waveguide.

32. An optical amplifier according to claim 30, wherein the pumping light supplied from said first pumping light supply system to said optical waveguide has a wavelength in a 1.4-μm band.

33. An optical waveguide comprised of a material at least partly containing a rare earth element;
wherein a wavelength region corresponding to a full width at half maximum of a spectrum of ASE generated in said optical waveguide when pumping light having a single wavelength is supplied thereto includes S, C, and L bands.

34. An optical waveguide according to claim 33, wherein said optical waveguide has a polarization dependent transmittance of less than 1 dB with respect to light transmitted therethrough from one end to the other end.

35. An optical waveguide according to claim 33, wherein the ASE outputted therefrom has a degree of polarization of 1 dB or less.

36. An optical waveguide according to claim 33, wherein the rare earth element includes Er element and Tm element.

37. An optical waveguide according to claim 36, wherein the rare earth element further includes Yb element.

38. An optical waveguide according to claim 36, wherein the Er element has a molar concentration set lower than that of the Tm element.

39. An optical waveguide according to claim 38, wherein the molar concentration of the Er element and the molar concentration of the Tm element have a ratio of 1:6 to 1:3 therebetween.

40. An optical waveguide according to claim 33, wherein said optical waveguide comprises a material mainly comprised of glass or glass ceramics having a phonon energy of 900 cm⁻¹ or less.

41. An optical waveguide according to claim 33, wherein said optical waveguide comprises a material mainly comprised of glass or glass ceramics having a phonon energy of 600 cm⁻¹ or less.

42. A light source comprising:
an optical waveguide according to claim 33; and
a first pumping light supply system for supplying said optical waveguide with pumping light.

43. A light source according to claim 42, further comprising:
an additional optical waveguide comprised of a material at least partly containing a transition metal element;
a second pumping light supply system for supplying said additional optical waveguide with pumping light; and
an optical multiplexer for combining the ASE generated in said optical waveguide with ASE generated in said additional optical waveguide.

44. A light source according to claim 42, wherein the pumping light supplied from said first pumping light supply system to said optical waveguide has a wavelength in a band of 1.4 μm.

45. An optical amplifier comprising:
an input end;
an output end;
an optical waveguide according to claim 33, disposed between said input end and said output end, for amplifying at least a part of a plurality of signal channels included in signal light taken therein by way of said input end; and
a first pumping light supply system for supplying said optical waveguide with pumping light.

46. An optical amplifier according to claim 45, further comprising:
an additional optical waveguide, disposed between said input end and output end and comprised of a material at least partly containing a transition metal element, for amplifying at least a part of a plurality of signal channels included in the signal light taken therein by way of said input end;
a second pumping light supply system for supplying said additional optical waveguide with pumping light;
an optical demultiplexer for demultiplexing the signal light taken therein by way of said input end, supplying a part of the demultiplexed plurality of signal channels to said optical waveguide, and supplying the rest of the plurality of signal channels to said additional optical waveguide; and
an optical multiplexer for combining the signal channels amplified by said optical waveguide with the signal channels amplified by said additional optical waveguide.

47. An optical amplifier according to claim 45, wherein the pumping light supplied from said first pumping light supply system to said optical waveguide has a wavelength in a 1.4-μm band.

48. An optical waveguide comprised of a material at least partly containing a rare earth element;
wherein a full width at half maximum of a spectrum of ASE generated in said optical waveguide when pumping light having a single wavelength is supplied thereto is at least 20 THz in terms of frequency.

49. An optical waveguide according to claim 48, wherein said optical waveguide has a polarization dependent transmittance of less than 1 dB with respect to light transmitted therethrough from one end to the other end.

50. An optical waveguide according to claim 48, wherein the ASE outputted therefrom has a degree of polarization of 1 dB or less.

51. An optical waveguide according to claim 48, wherein the rare earth element includes Er element and Tm element.

52. An optical waveguide according to claim 51, wherein the rare earth element further includes Yb element.

53. An optical waveguide according to claim 51, wherein the Er element has a molar concentration set lower than that of the Tm element.

54. An optical waveguide according to claim 53, wherein the molar concentration of the Er element and the molar concentration of the Tm element have a ratio of 1:6 to 1:3 therebetween.

55. An optical waveguide according to claim 48, wherein said optical waveguide comprises a material mainly comprised of glass or glass ceramics having a phonon energy of 900 cm⁻¹ or less.

56. An optical waveguide according to claim 48, wherein said optical waveguide comprises a material mainly comprised of glass or glass ceramics having a phonon energy of 600 cm⁻¹ or less.

57. A light source comprising:
an optical waveguide according to claim 48; and
a first pumping light supply system for supplying said optical waveguide with pumping light.

58. A light source according to claim 57, further comprising:
an additional optical waveguide comprised of a material at least partly containing a transition metal element;
a second pumping light supply system for supplying said additional optical waveguide with pumping light; and
an optical multiplexer for combining the ASE generated in said optical waveguide with ASE generated in said additional optical waveguide.

59. A light source according to claim 57, wherein the pumping light supplied from said first pumping light supply system to said optical waveguide has a wavelength in a band of 1.4 μm.

60. An optical amplifier comprising:
an input end;
an output end;
an optical waveguide according to claim 48, disposed between said input end and said output end, for amplifying at least a part of a plurality of signal channels included in signal light taken therein by way of said the input end; and
a first pumping light supply system for supplying said optical waveguide with pumping light.

61. An optical amplifier according to claim 60, further comprising:
an additional optical waveguide, disposed between said input end and output end and comprised of a material at least partly containing a transition metal element, for amplifying at least a part of a plurality of signal channels included in the signal light taken therein by way of said input end;
a second pumping light supply system for supplying said additional optical waveguide with pumping light;
an optical demultiplexer for demultiplexing the signal light taken therein by way of said input end, supplying a part of the demultiplexed plurality of signal channels to said optical waveguide, and supplying the rest of the plurality of signal channels to said additional optical waveguide; and
an optical multiplexer for combining the signal channels amplified by said optical waveguide with the signal channels amplified by said additional optical waveguide.

62. An optical amplifier according to claim 60, wherein the pumping light supplied from said first pumping light supply system to said optical waveguide has a wavelength in a 1.4-μm band.
